(19) United States
(12) Patent Application Publication
(10) Pub. No.: US 2009/0231686 A1
(43) Pub. Date: Sep. 17, 2009

(54) MULTI-FUNCTIONAL INTEGRATED OPTICAL WAVEGUIDES

(76) Inventors: Robert Atkins, Bryan, TX (US); Christi Kay Madsen, Hearne, TX (US); John C. Simcik, Elm Mott, TX (US)

Correspondence Address: EMMA Co LLC;John Simcik, 544B Gerald Lane, Elm Mott, TX, 76640, US

(21) Appl. No.: 12/351,852

(22) Filed: Jan. 12, 2009

Related U.S. Application Data
(60) Provisional application No. 61/020,709, filed on Jan. 12, 2008.

(51) Int. Cl. H04B 10/12; G02B 6/26

(52) U.S. Cl. 359/341.3; 385/28

(57) ABSTRACT

This invention pertains to a device and method for making same. The device includes a substrate supporting optical waveguide, an overlay waveguide and a mode coupler for coupling between the substrate-supported and overlay waveguides. One embodiment includes a high-confinement overlay waveguide capable of low-loss bends with small bend radii, down to tens of microns, which represents two orders of magnitude improvement over prior art. One embodiment includes a feedback path enabled by the high-confinement waveguide, capable of implementing tunable ring resonator filters with free spectral ranges over 100 GHz and modulators with compact and interferometrically stable feedback paths. Another embodiment includes a periodically poled lithium niobate section capable of integrating wavelength conversion within a compact feedback path. Another embodiment includes an amplifier section, which may be incorporated in the feedback path. Thus, multi-functional integrated optical waveguides are disclosed that enable high-density integration of multiple linear and nonlinear optical processing functions.

### CROSS-REFERENCE TO RELATED APPLICATIONS

This application claims the benefit of provisional patent application Ser. No. 61/020,709, filed 2008 Jan. 12, by the present inventors.

### FEDERALLY SPONSORED RESEARCH

Not applicable.

### SEQUENCE LISTING OR PROGRAM

Not applicable.

### BACKGROUND

1. Field of the Invention

This invention relates to integrated optical devices for modulation, routing, filtering, wavelength conversion, amplification and nonlinear processing of optical signals. Applications include optical communications, optical sensing and high-speed, high-bandwidth analog and digital processing in the optical domain.

2. Prior Art

High-speed optical modulators for telecommunications typically use lithium niobate waveguides, since lithium niobate is an electro-optic material whereby a change in the phase of an optical signal can be induced by applying a voltage across nearby electrodes. Typical lithium niobate waveguides are made using titanium-indiffusion or proton exchange. The resulting waveguides have low optical confinement which effectively means they can only achieve low loss for bend radii larger than about 1 centimeter in the 1400 nm to 1620 nm wavelength range, important for low loss optical fiber transmission, without incurring excess loss. This bend radius restriction substantially limits the number of optical devices and functions that can be fabricated on a single substrate, or on-chip. Consequently, the type and quality of optical filtering that can be realized on-chip is exceedingly limited.

The bend radius, and thus optical circuit size, must be increased further for operating in the mid-infrared, e.g. 2 to 4 micron wavelength range. The mid-infrared wavelengths are important for optical sensing applications where many chemicals. In particular, environmentally-important gases such as carbon monoxide, carbon dioxide, methane, sulfur dioxide and nitrous oxide have ro-vibrational absorption signatures that make them easily identifiable in the mid-infrared.

In addition to increasing the level of integration that can be achieved, it is highly desired to increase the interaction length for high-speed optical modulators in order to lower the drive voltage. One approach is to turn the optical mode by 180 degrees by creating a reflector at the chip facet or etching about ten microns into the lithium niobate and depositing a reflector so that the signal can propagate across the chip multiple times as described in M. Howerton, et al., “Low-loss compact reflective turns in optical waveguides,” U.S. Pat. No. 6,862,387 B2 (2005). The fabrication process for the reflector requires numerous steps and precise alignment to minimize the excess loss. Improvements are needed in reducing the excess loss and circuit size further as well as improving the manufacturability of compact waveguides on electro-optic substrates such as lithium niobate, in particular.

### Optical Amplifiers

When the optical path lengths are dramatically increased on-chip, a concern arises over compensating the waveguide loss in order to integrate more functionality. Erbium, Er, doping in lithium niobate, LiNbO₃, enables integrated optical waveguide amplifiers for applications in the 1550 nm wavelength regime. For example, optical amplification in titanium, Ti, diffused LiNbO₃ waveguides has been demonstrated near 1530 nm [for example, see R. Brinkmann et al. in “Erbium-doped single- and double-pass Ti: LiNbO3 waveguide amplifiers,” J. Quant. Electron., pp. 2356-2360 (1994)]. The length of the amplifiers is currently limited by the die size. The ability to turn the waveguide using a compact bend would be highly beneficial in enabling higher gain amplifiers to be implemented, without the concern about unwanted reflections that may be associated with prior art reflection-based waveguide turning approaches.

### Nonlinear Waveguides

Wavelength conversion from the 1.5 micron to the mid-infrared (3-5 microns) wavelength range can be performed using periodically poled lithium niobate (PPLN), and similarly for conversion between other wavelength regions. Wavelength conversion from the near-infrared to mid-infrared has been demonstrated in both bulk PPLN and PPLN waveguides. Implementations using bulk PPLN are limited by the fundamental tradeoff between the interaction length and minimum spot size due to beam diffraction. Optical waveguides provide a means of extending the interaction length and the ability to enhance the nonlinear interaction by increasing the optical mode confinement and thereby increasing the intensity of the pump wavelength driving the nonlinear wavelength conversion process. In addition, PPLN waveguide devices offer the potential to be a more compact solution than bulk approaches with more stable and robust packaging.

State-of-the-art waveguide-based wavelength converters using lithium niobate are substantially limited in their conversion bandwidth. High-refractive-index blanket coatings (not waveguides) of As₂S₃ have been investigated for 1.5 μm-band wavelength converters and z-cut, annealed proton exchange waveguides [see Sato et al., “Efficiency improvement by high-index cladding in LiNbO3 waveguide quasi-phase-matched wavelength converter for optical communication,” in IEEE Photon. Technol. Lett., pp. 569-571 (2003). Different PPLN waveguide fabrication processes have successfully been employed in Ti-indiffusion [see D. Hofmann et al., “Quasi-phase-matched difference-frequency generation in periodically poled Ti:LiNbO3 channel waveguides,” in Opt. Lett., pp. 896-898 (1999)]. Thus, substantial improvements are needed to advance the bandwidth and efficiency of wavelength converters, particularly for mid-infared wavelength generation. Within the 1550 nm telecommunications window, frequency shifting applications using four wave mixing are needed for signal processing applications of wavelength division multiplexed signals.

### SUMMARY OF THE INVENTION

This invention relates to a novel optical waveguide platform for the high-density integration of multiple linear and nonlinear optical processing functions. Integrated-optic waveguides are preferred over bulk implementations for nonlinear processing because the propagation distance is not diffraction limited and the mode size can be made small without impacting the propagation distance. The level of integration for optical processing functions such as routing, modulation, switching, and filtering in lithium niobate waveguides is substantially hindered by their inherent low mode confinement, preventing optical circuits with tight bend radii (less than a millimeter) to be achieved. Optical filtering, in particular, is rarely done on-chip because it requires coupling between multiple, long optical paths. For nonlinear processing, the refractive index dispersion of nonlinear materials often limits the wavelength range over which the nonlinear process is optimized.

This disclosure provides the foundation for increasing the integration density of optical elements and functionality, for example, on a lithium niobate substrate. The novel waveguide platform that is disclosed offers an unprecedented combination of high-density, high-functionality integration using an exemplar combination of chalcogenide glass waveguides on lithium niobate, which enables high-speed modulation and reconfigurability, low-loss and low-power-consumption phase shifters, as well as amplification through erbium doping of the lithium niobate. This new waveguide platform can be exploited to demonstrate integration of polarization beam splitters and rotators for polarization diversity and polarization tuning.

For the wavelength converter, the necessary course wavelength combiners and splitters are easily integrated on-chip. This combination of high-confinement waveguides and low-loss, low-confinement waveguides for high-efficiency, broadband wavelength conversion, and increased optical integration density will enable a compact and robust wavelength converter package. Thus, this disclosure makes it possible to combine both linear and nonlinear waveguides, optimize their design, and integrate them monolithically.

### BRIEF DESCRIPTION OF THE DRAWINGS

The advantages, nature and various additional features of the invention will appear more fully upon consideration of the illustrative embodiments now to be described in detail in connection with the accompanying drawings. In the drawings:

FIG. 1a is a cross-sectional view of a multi-functional waveguide and FIG. 1b is a schematic of a phase modulator with small bend radii.

FIG. 2. is a vertically integrated ring resonator using a high-confinement waveguide feedback path coupled to a low-confinement waveguide.

FIG. 3. is an optical filter containing a birefringent, low-confinement waveguide, polarization converters and a vertically-integrated, high-confinement waveguide ring resonator.

FIG. 4. shows a multi-functional integrated waveguides with voltage-controlled phase shifters, optical amplification, high-confinement ring resonator, and polarization controllers.

FIG. 5. is a wavelength converter integrating linear and nonlinear functions on a common substrate, including phase shifting or modulation.

It is to be understood that these drawings are for illustrating the concepts of the invention and are not to scale.

### DETAILED DESCRIPTION

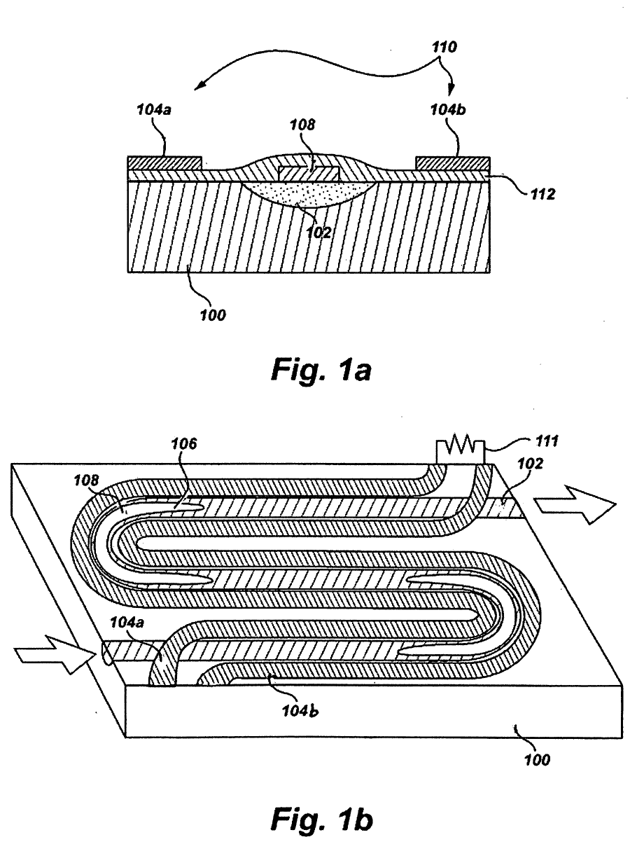

Referring to the drawings, FIG. 1a illustrates a cross-section of a multi-functional waveguide platform composed of substrate 100 with waveguide 102 and electrodes 104a and 104b. Substrate 100 can be any suitable material, including ferroelectric materials such as lithium niobate (LiNbO₃), lithium tantalate (LiTaO₃), barium titanate (BaTiO₃), and various polymers with electro-optic properties and semiconductors such as indium phosphide (InP), indium gallium arsenide phosphide (InGaAsP), gallium arsenide (GaAs), and gallium aluminum arsenide (GaAlAs). The waveguide 102 has a higher refractive index than the substrate in order to guide an optical mode, and is subsequently referred to as a substrate-supported waveguide to differentiate it from other waveguides to be discussed. In LiNbO₃, waveguide 102 is typically made using titanium-diffusion or proton exchange. The description that follows will be made in the context of titanium-diffused waveguides in lithium niobate substrates, although it is understood that other materials can be used. Overlay waveguide 108 is patterned from a material having a higher refractive index than the substrate 100 and waveguide 102. Any material having a higher refractive index is suitable for overlay waveguide 108. For example, LiNbO3 has a refractive index of 2.1 to 2.2, depending on the polarization, in the 1550 nm wavelength region. Chalcogenide glasses are amorphous materials with at least one of the chalcogen elements; Se, Te, and S. Arsenic-trisulfide (As₂S₃) is a binary glass and a member of the chalcogenide glass family. Chalcogenide glasses such as arsenic trisulfide with a refractive index around 2.4 at a wavelength of 1550 nm are well-suited to form overlay waveguides on LiNbO3 substrates. Other chalcogenide glass compositions are suitable for the overlay material as well as silicon, germanium, and other semiconductor materials with a higher refractive index than the substrate waveguide 102. Beneficially, the chalcogenide glasses are easily deposited on a substrate in a low-optical-loss amorphous state, and they are transparent in the mid-infrared. Some compositions have nonlinear coefficients that exceed that of silica by over a factor of 500. Chalcogenide glasses that may be used for the overlay and have different nonlinear coefficients and refractive indices from As₂S₃, with preferred ratios of the constituent elements that are suitable for glass forming, include germanium arsenic selenide (Ge—As—Se), germanium antimonide selenide (Ge—Sb—Se), arsenic selenide (As—Se), or arsenic selenide tellurium (As—Se—Te).

Electrode 104a and 104b operate as a pair, whereby one active electrode driven by an applied voltage and a ground electrode form a pair. One or more ground electrodes may be used. FIG. 1a assumes an x-cut LiNbO3 substrate. For this crystal orientation, an electric field is created horizontally, with respect to the substrate, across the gap between electrode pair 110. The electric field induces a change in the refractive index of waveguide 108, which creates a phase shift in the transmitted optical signal. The amount of phase shift depends on the applied voltage. Other crystal orientations may also be used. For z-cut LiNbO3 substrates (not shown), an electric field is induced in waveguide 108 that is vertical with respect to the substrate and the active electrode is placed above waveguide 102 instead of being offset from it as shown in FIGS. 1a and 1b. In this case, it is common to use symmetric ground electrodes around the active electrode.

Buffer layer 112 comprises a material with a lower refractive index than the substrate and overlay waveguide material and that is optically transparent in the wavelength range of operation. Silicon dioxide is an example of a suitable buffer layer material to be used with lithium niobate and As2S3. Other glasses and polymers are also suitable. Buffer layer 112 provides a protective overcladding for overlay waveguide 108.

Buffer layer 112 separates the electrodes 104a and 104b from the optical mode traveling in either waveguide 102 or 108 when an electrode is above or in close proximity to the waveguide.

FIG. 1b illustrates a serpentined electro-optic phase modulator composed of substrate 100 with waveguide 102 and electrode 104a and 104b. An optical source is coupled to waveguide 102, typically through a singlemode optical fiber. For low loss coupling to a singlemode fiber, it is advantageous for waveguide 102 to be relatively low-confinement so that the mode couples efficiently to a singlemode fiber. Titanium-diffused lithium niobate waveguides are low-confinement waveguides and couple well to singlemode optical fiber. The phase of the optical signal is modulated by applying a voltage to electrode pair 110. The optical signal is then coupled to waveguide 108 via a mode coupler 106 that comprises a small waveguide width for the end point of the overlay material, typically 0.5 to 1.0 microns for As₂S₃ on LiNbO₃, and tapers to a larger waveguide width, typically a few microns for As₂S₃ on LiNbO₃. Waveguide 108 is a high-confinement waveguide that is capable of low-loss bend radii down to tens to hundreds of microns. Buffer layer 112 protects the overlay waveguide material and provides a buffer, separating the optical mode from the electrodes, which is particularly important where the electrodes are on top of or in close proximity to either the overlay waveguide or electro-optic waveguide. For x-cut lithium niobate substrates, the electrodes are placed to either side of the electro-optic waveguide. Traveling wave electrodes, which are designed for predetermined impedance, are used to maximize the modulation bandwidth and minimize reflections of the high-speed electrical drive signal. One end of the electrode pair is driven with a radio frequency or microwave source, while the other is terminated in a matching impedance load 111 to minimize reflections. For z-cut lithium niobate substrates (not shown), one electrode is positioned directly above the electro-optic waveguide while a second electrode is offset from it. The phase modulator illustrates in FIG. 1b may be combined with optical splitters (not shown) to create an amplitude modulator.

### High-confinement Waveguides

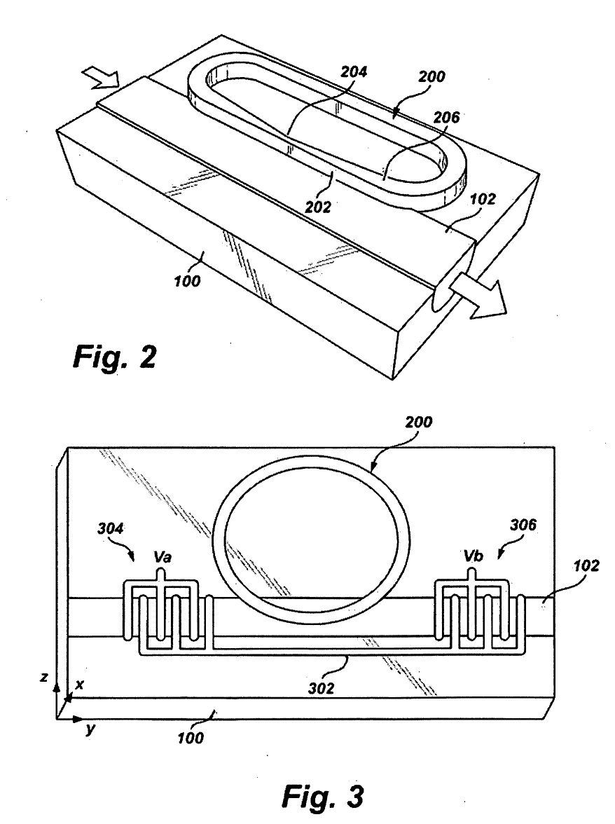

FIG. 2 shows an optical waveguide ring resonator comprising a feedback path 200 integrated on substrate 100. The feedback path of the ring resonator couples to the substrate-supported waveguide through mode coupler 202 whereby the overlay waveguide is in close proximity to waveguide 102. Mode coupler 202 comprises two input waveguides and two output waveguides, i.e. one substrate-supported and one overlay waveguide on both the input and output; whereas, mode coupler 106 comprises two input waveguides and one output waveguide or vice versa, depending on the direction of propagation. Thus, the mode couplers can be differentiated based on their number of input and output waveguides, for example, 106 is a 1×2 mode coupler while 202 is a 2×2 mode coupler. The overlay waveguide may be tapered from a nominal width waveguide 206 to a smaller width waveguide 204 in the mode coupling region to improve the coupling between the overlay and waveguide 102. In addition, the offset between the center of the overlay and electro-optic waveguides may be varied in the mask design to provide a predetermined mode coupling ratio.

By using a chalcogenide glass such as arsenic trisulfide to fabricate a high-confinement waveguide on lithium niobate, simulations show that low-loss bend radii on the order of 100 microns can be achieved. For a bend radius of 150 microns and a group index of 2.2, ring resonators with a free spectral range (FSR) up to 145 GHz can be realized. For optical filtering, it is desirable to have FSRs that are larger than the modulated signal bandwidth, thus achieving low-loss waveguides with small bend radii is critical for enabling advanced optical filtering on-chip. For larger index contrasts, for example by using a different chalcogenide composition with a higher refractive index, tighter bend radii and even larger FSRs can be realized.

To couple between the waveguide layers, one solution is to use adiabatic mode transforming tapers from the low-confinement substrate waveguide into a high-confinement overlay (e.g. As₂S₃) waveguide. Simulations using a beam propagation method show that efficient transfer of light, better than 95% mode transfer, can be achieved between the vertically integrated waveguides.

### Polarization Tunable Filter

FIG. 3 shows a novel optical filter using an overlay ring resonator 200 on an electroptic substrate 100. The coupling between the ring resonator and waveguide 102 is polarization dependent. The coupling may be changed by varying the offset between the ring overlay waveguide and waveguide 102 in the mask design. Additionally, the coupling is polarization dependent and may be varied by choosing a different waveguide width and/or thickness for the overlay waveguide. An interdigitated electrode pair, consisting of an active electrode 304 and a ground electrode 302, induce a periodic variation in the refractive index that couples the incoming light from one polarization (e.g. horizontal) to the orthogonal polarization (e.g. vertical). A voltage Vₐ is applied to electrode 304 while electrode 302 is held at ground. A common ground electrode may be shared amongst several interdigitated electrodes. An optical source, for example that is horizontally polarized, is coupled to the electro-optic waveguide. By varying the voltage to electrode 304, the portion of light that is converted to vertical polarization may be varied. The vertical polarized light sees a different filter response upon transmission through the ring than the horizontally polarized light. For example, the ring may be designed to support the TE polarization, letting the TM polarization bypass the ring without coupling into it. At the second interdigitated electrode pair, 306 and 302, a portion of the horizontally polarized light is converted to vertically polarized light, and vice versa, depending on the applied voltage V_{b}. Thus, the overall optical filter response may be tuned by changing the voltages Vₐ and V_{b}.

While previous optical filters have employed symmetric Mach-Zehnder interferometers with allpass filters in each arm [for example see C. Madsen in “Efficient Architectures for Exactly Realizing Optical Filters with Optimum Bandpass Designs,” in IEEE Photonics Technol. Lett., pp. 1136-1138 (1998)], the disclosed novel design uses polarization converters to tune the filter parameters in FIG. 3, consisting of two polarization mode couplers with an intervening ring resonator formed in a vertically-integrated high-confinement waveguide. The polarization mode couplers 304 and 306 provide polarization conversion electro-optically between TE and TM modes through applied voltages Vₐ and V_{b}. Polarization conversion is obtained by applying voltage to interdigitated electrodes on a properly oriented lithium niobate wafer.

Multiple rings can be incorporated in a Mach-Zehnder interferometer to produce frequency responses identical to elliptic, Butterworth and Chebyshev filter designs [see previous reference to C. Madsen (1998)], to name a few of the possibilities. The elliptic infinite impulse response (IIR) filter, in particular, gives the most efficient boxlike bandpass filter amplitude response for the fewest stages. For higher-order filters, multiple rings are needed in each arm of the interferometer. To do this with birefringent waveguides and polarization mode coupling, we propose to cascade stages of the basic architecture shown in FIG. 3. Each stage would consist of a polarization converter and feedback path with mode coupler. A final polarization converter would be cascaded to the last stage. With two stages, the first and last polarization mode converters may be designed to provide a conversion efficiency of 50% while a middle converter swaps the TE and TM polarizations, i.e. 100% conversion. For example, an incoming TE-polarized signal splits evenly into the first stage with 50% of the power in TE and 50% in the TM mode. The TE-mode propagates through the ring resonators, picking up the allpass filter response. The TE-mode then converts to TM and vice versa at the middle converter so that the second set of rings operate on what was previously the TE response in the first stage. Finally, the TE and TM modes mix in equal portions at the final polarization mode converter yielding the sum and difference of the allpass filters in each stage.

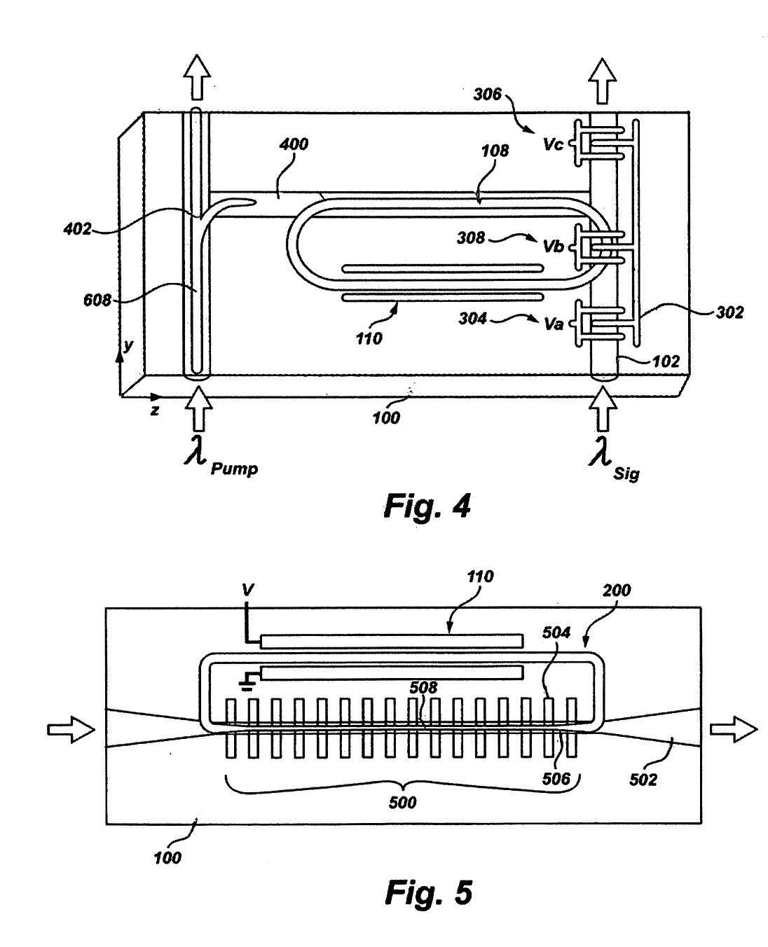

To realize programmable filters, both the optical phase of the delay path and the coupling into the feedback path must be tunable. FIG. 4 discloses a tunable architecture whereby a polarization mode converter provides tunable coupling into the ring feedback path.

Power consumption is negligible for the electro-optic electrodes that are used for polarization conversion and phase control since they are high impedance with practically zero leakage current. In contrast, traveling-wave modulators need to have a 50-ohm impedance to match the electrical driver. In which case, achieving modulators with low V_{π} voltages (the voltage required to shift the phase by π) is critical to reducing the power consumption. Switching energies are estimated at 30 mW per polarization converter section and 20 mW per phase controller. By using the electro-optic effect, the power consumption associated with thermal tuning or current injection, that are typical with other dielectric and semiconductor integrated-optic platforms, is avoided.

Integrated Optical Devices with Gain

FIG. 4 shows multi-functional waveguides that integrate gain, modulation, polarization control and filtering. An electro-optic substrate 100 incorporates both regular waveguides 102 and waveguide amplifier 400. A waveguide amplifier 400 may be made by diffusing erbium into a titanium waveguide 102 and pumping the Er-diffused waveguides with a suitable pump laser. Typical pump wavelengths λₚᵤₘₚ for erbium-doped amplifiers are 1480 nm and 980 nm, which will amplify signal wavelengths λ_{sig} around 1530 nm. A ring resonator may couple to the amplifier section so that gain is obtained as part of the roundtrip propagation of the signal around the ring resonator. An electrode pair 110 is incorporated in the ring to vary the resonant frequency of the ring. By using a traveling wave electrode, high-speed modulation may be achieved. The optical pump source is coupled to a low-confinement waveguide 102 that may be coupled to a high-confinement waveguide 608 as shown in FIG. 4. A splitter 402 may be used to couple a portion of the pump light to a particular ring resonator or amplified section so that one pump may supply many amplifier sections.

The incorporation of gain in the feedback path offers a unique capability for the design of high-order optical filters compared to passive filters. First, the gain can offset the feedback path loss. Thus, ideal allpass optical filters may be realized with a unity magnitude response. A novel device results when gain is employed in a feedback path that is coupled to two input/output waveguides. With sufficient gain in the feedback path, one of the thru-port responses can be made allpass, i.e. the response will demonstrate no amplitude variation with frequency but its phase response can be made to vary dramatically with frequency. This is not possible with a passive filter because there is loss associated with transmission through the second coupler (compared to an allpass ring with a single coupler).

In general, increasing the gain in the feedback path will increase both the pole and zero magnitudes in an IIR filter. The pole magnitudes must be kept less than unity to insure stability. Increasing the loss in the delay path will likewise decrease both the pole and zero magnitudes. The magnitude response may exceed unity, particularly as the pole approaches the unit circle. For a single pole and zero, the architecture with an amplifier in the feedback path allows tuning without requiring a tunable filter in the ring's feedback path. By tuning the gain, it is possible to achieve a range of pole magnitudes without changing the coupling into the feedback path.

### Tunable Filter

For high-order optical filters, it is desirable to implement a filter from well-known “unit cells”, analogous to “unit cells” in electronic field programmable gate arrays (FPGA). The “unit cells” may then be connected as necessary to form a programmable array. An optical filter “unit cell” is disclosed in FIG. 4. It consists of a ring resonator coupled to a bus waveguide. Electro-optic phase control of the resonant frequency is provided. To control the coupling into the feedback path, polarization converters are used. Optical gain is provided via orthogonally-oriented erbium-doped lithium niobate waveguides. A gain of 1 dB/cm is achievable near the peak gain wavelength of λ=1531 nm. The mode confinement in the high-index contrast waveguide may be reduced in the amplifier sections to maximize the overlap with the gain medium. The pump power, and thus gain, to each resonator may be individually controlled. Electro-optically controlled Y-branch splitters and polarization converters may be used for gain control.

### Wavelength Conversion

FIG. 5 shows an embodiment for wavelength conversion that can be included as part of a multi-functionality optical waveguide platform. A combined process of masking and poling, lithium niobate for example, under a high voltage is sufficient to reverse the domain in a localized region 504. Through periodic domain reversal, achieved for example by periodically poling lithium niobate, the substrate's nonlinear properties can be used to generate a new wavelength from an incoming signal and pump source. Various nonlinear processes such as four wave mixing, sum frequency generation and difference frequency generation may be implemented using PPLN section 500. The period of the domain reversed regions is chosen to phase-match predetermined frequencies of interest, i.e. match the difference in propagation constants at the mixing frequencies, to enhance the nonlinear mixing process for wavelength conversion. A high-confinement ring resonator 200 is incorporated as well as an electrode pair 110 for tuning the resonant frequency. The ring resonator provides a compact feedback path to multi-pass the PPLN section 500 and improve the wavelength conversion efficiency for a given signal and pump power. Four wave mixing may be employed for frequency shifting within the feedback path. A narrow-width high-confinement waveguide 508 is employed over the PPLN section so that the dominant portion of the mode travels in the substrate and not the overlay waveguide. Typically, high pump powers are required to achieve reasonable wavelength conversion efficiencies, so it is advantageous to have larger mode sizes, and thus waveguide widths 502, so that the intensity is reduced at the fiber-to-waveguide coupling to minimize the chance of optical damage.

This invention provides design control over the mode confinement, mode effective index, and mode group index as a function of wavelength by using two optical waveguiding materials with different refractive indices. The wavelength conversion bandwidth is a major limitation for the generation of mid-IR wavelengths using periodically poled lithium niobate (PPLN). By overlaying a high-refractive-index material on the PPLN waveguide and optimizing the width and thickness that allows us to match the group index of the signal and idler wavelengths, over an order of magnitude conversion bandwidth improvement can be achieved. The wavelength conversion bandwidth compared to that with no overlay, for both a waveguide and bulk configuration shows over a factor of 20 improvement in simulation.

For wavelength conversion, we disclose a fully integrable optical parametric oscillator (OPO) solution, shown in FIG. 5, that alleviates the need to go off chip to build a resonator. It consists of mode transformers on the input and output to couple efficiently to large mode fibers. An overlay waveguide couples the signal wavelength out of the substrate-supported waveguide and redirects it along a feedback path 200. The substrate-supported waveguide is maintained straight so as not to induce bend losses for the long-wavelength mid-IR. This configuration will allow us to maximize the length of the nonlinear conversion region containing the periodically poled grating. Electro-optic tuning of the signal in the feedback path allows constructive interference for the signal wavelength as the pump wavelength is tuned. For near-degenerate mid-IR generation, mode couplers based on multi-mode interference (MMI) can be incorporated to separate the signal and wavelength converted, also called idler, wavelengths. MMI couplers will benefit from the high-index overlay and allow us to keep the idler in a straight waveguide, thus avoiding y-branches and bends that accompany other mode transformer solutions which will be very problematic for the longer wavelengths because of the lower mode confinement and thus higher bend loss.

Having described the invention, the following example is given as a particular embodiment thereof and to demonstrate the practice and advantages thereof. It is understood that the example is given by way of illustration and is not intended to limit the specification of the claims in any manner.

### EXAMPLE

An example of the fabrication steps for multi-functional integrated waveguides are set forth below for operation at 1.55 microns.

An optical amplifier may be fabricated in lithium niobate by sputtering a thin layer (e.g. 90 angstrom-thick) of erbium on the surface of the lithium niobate substrate. A mask is used to localize the Er deposition, or dopant, to predetermined regions so that the whole substrate is not doped. Regions which are doped require optical pumping; otherwise, large optical losses result in un-pumped regions, especially near 1530 nm. After Er deposition, diffusion is carried out in an oxygen ambient at 1100° C. temperature for 100 hours in an open tube furnace. Optical channel waveguides are then fabricated using a standard Ti-diffusion and waveguide patterning processes. An example process for making LiNbO₃ waveguide devices involves (1) deposition of thin (120 nm) layer of Ti film on the surface of the substrate, (2) patterning the Ti film by a process of photolithography and etching, and (3) diffusing the Ti into the substrate at 1025° C. for 11 hours in wet ambient. For the PPLN section, the waveguide fabrication steps involve forming the domain-inverted grating after the Ti-indiffused waveguides. Standard photolithography techniques are used, to localize the PPLN region and create the periodic pattern to be poled. Electric-field poling is used to invert the domains.

After the substrate processing, As₂S₃ is deposited using an RF sputtering method that is least vulnerable to compositional difference between the target and the deposited film compared to other deposition techniques such as electron beam evaporation and pulsed laser deposition. The overlay films are annealed at 135° C. for two hours afterwards. Since As₂S₃ is attacked by developer solutions due to their alkali content, a SiO2 and titanium layers of thicknesses 230 nm and 15 nm are coated on top of As₂S₃ as a protective layer before the lithography step. The final waveguide structures are obtained after reactive-ion etching and photoresist removal. A protective overcladding of silicon dioxide is sputtered, or deposited by electron beam evaporation, to protect the As₂S₃ waveguides and to provide a buffer oxide layer on which to deposit electrodes.

For electro-optic control, phase shifters are implemented using a 200-nm-thick SiO₂ buffer layer, deposited by RF sputtering. The electrodes may be delineated by liftoff using Cr/Au metal layers. Other electro-optically controlled devices such as an active Y-junction [for example, see H. Sasaki and I. Anderson, “Theoretical and experimental studies on active Y-junctions in optical waveguides,” in IEEE J. Quant. Electron., pp. 883-892 (1978)] may be implemented using these processes. The samples are polished as a last step before optical testing by coupling light into the waveguides.

While presently preferred embodiments have been shown of the optical waveguide devices and method for their fabrication and operation, persons skilled in this art will readily appreciate that various additional changes and modifications can be made without departing from the spirit of the invention as defined and differentiated by the following claims.

What is claimed is:

1. An optical device for compactly integrating multiple functionalities on a common substrate, comprising:
a substrate supporting at least one optical waveguide;
at least one overlay waveguide with a higher effective refractive index than the substrate-supported optical waveguide;
at least one mode coupler to transfer the optical mode between the substrate waveguide and overlay waveguides

2. The device according to claim 1, wherein said substrate comprises at least one of lithium niobate, lithium tantalate, barium titanate, strontium barium titanate, and wherein said substrate-supported optical waveguide compose at least one of titanium-diffused waveguide and proton exchange waveguide.

3. The device according to claim 1, wherein said overlay comprises at least one of arsenic trisulfide, silicon, germanium or chalcogenide glass waveguides with elemental compositions including Ge—As—Se, Ge—Sb—Se, As—Se, or As—Se—Te.

4. The device according to claim 1, further comprising at least one active electrode and one or more ground electrodes.

5. The device according to claim 1, wherein at least one of the substrate or overlay waveguide materials has a nonlinear optical response and can be used for wavelength conversion, or frequency shifting.

6. The device according to claim 1, further comprising said overlay waveguide with one or more waveguide sections having a bend radius less than 1 mm.

7. The device according to claim 1, further comprising said overlay waveguide forming a closed feedback path that is optically coupled to said substrate waveguide.

8. The device according to claim 7, further comprising an electrode for tuning the resonant frequency of the feedback path.

9. The device according to claim 7, further comprising one or more interdigitated electrode pairs,
whereby the polarization mode coupling may be actively tuned through voltage control and consequently change the filter response of a ring resonator.

10. The device according to claim 7, further comprising one or more mode couplers to a second substrate-supported waveguide,
whereby an optical filter with an additional output response may be achieved.

11. The device according to claim 1, further comprising an optical amplifier; wherein localized gain regions are incorporated in sections of the substrate.

12. The device according to claim 7, further comprising an optical amplifier within the feedback path.

13. The device according to claim 1, further comprising a periodic region of domain reversals for wavelength conversion, or frequency shifting.

14. The device according to claim 7, further comprising a periodic region of domain reversals for wavelength conversion, or frequency shifting, within the feedback path.

15. The device according to claim 1, further comprising a mode expander for the delivery of high-power pump light to said nonlinear waveguide to reduce the probability of photoinduced damage and enable operations at higher optical powers.

16. A method of making a device for compact multi-functional integration comprising:
providing an optical waveguide on a substrate;
providing an overlay waveguide; and
providing a mode coupler to couple the optical signal efficiently between the substrate waveguide and overlay waveguide.

17. The method according to claim 15, further comprising:
providing a buffer layer; and
providing one or more electrode pairs,
wherein the buffer layer separates the optical mode from the electrodes, thereby preventing the optical mode from experiencing large absorption losses from being in too close proximity to the electrode material.

18. The method according to claim 15, further comprising:
providing an optical waveguide amplifier,
wherein a mask is used to localize the doping to predetermined regions so that the whole substrate is not doped, which would require optical pumping to avoid large optical losses in un-pumped regions.

19. The method according to claim 15, further comprising:
providing a periodic domain reversal section that overlaps one or more substrate waveguides,
wherein the periodic domain reversal section may be incorporated in a feedback path.
